(19) United States
(12) Patent Application Publication
(10) Pub. No.: US 2002/0196142 A1
(43) Pub. Date: Dec. 26, 2002

(54) PICTURE TAKING AND TRANSMITTING APPARATUS AND SECURITY SYSTEM AND TRAFFIC SECURITY SYSTEM USING THE SAME

(76) Inventors: HUNG-WEN WANG, KEELUNG (TW); CHEN-MING WU, KEELUNG (TW); HUNG-CHI LIN, KEELUNG (TW); HAN-TSOU CHEN, KEELUNG (TW); KUO-CHING HSIEH, KEELUNG (TW)

Correspondence Address: Alan Kamrath, Rider Bennett Egan & Arundel LLP, 333 South Seventh Street, Suite2000, Minneapolis, MN, 55070, US

(21) Appl. No.: 09/480,771

(22) Filed: Jan. 10, 2000

(30) Foreign Application Priority Data
Jan. 12, 1999 (TW) 88100483

(51) Int. Cl. G08B 13/00

(52) U.S. Cl. 340/541; 340/539; 340/521; 340/522

(57) ABSTRACT

An apparatus for taking and transmitting picture includes a picture-taking device for taking pictures and for transforming the pictures into data and a data-transmitting device for transmitting the data transformed by means of the picture-taking device. The picture taking and transmitting devices may be used in a security system. The security system includes a controller and a sensing device. On sensing an external force, the sensor notifies the controller that in turn actuates the picture-taking device and the data-transmitting device. The picture taking and transmitting apparatus may be used in traffic security system. The traffic security system includes a controller and a sensing device. On sensing a vehicle running faster than a speed limit or across a stop line, the sensor notifies the controller that in turn actuates the picture-taking device and the data-transmitting device.

### BACKGROUND OF THE INVENTION

1. Field of the Invention

The present invention is related to a picture taking and transmitting apparatus and a security system and a traffic security system using the same.

2. Description of the Related Art

There are more and more vehicles and unfortunately there are more and more cases of invasion against or burgling of vehicles. To stop or scare off invaders or burglars, there have been various security apparatuses and security systems.

There have been various locks for steering wheels of vehicles. Such a lock is used to lock a steering wheel of a vehicle in a fixed position. Thus, a burglar can not drive the vehicle away for being incapable of controlling the direction of the travel of the vehicle.

There have been various locks for gear shift sticks of vehicles. Such a lock is used to lock a gear shift stick of a vehicle in PARK gear so that a burglar can not drive the vehicle away.

There has been a lock for braking systems of vehicles. A typical vehicle includes a braking system consisting of a number of brakes, a hydraulic system linked to the brakes and a pedal connected with the hydraulic system. When the pedal is stepped on, hydraulic pressure in the hydraulic system is increased in order to actuate the brakes. Such a lock is in liquid communication with the hydraulic system. To prevent the travel of the vehicle, the pedal is stepped on so as to increase the hydraulic pressure in the hydraulic system in order to actuate the brakes. Then, the lock is actuated in order to retain the increased hydraulic pressure so as to retain the actuation of the brakes. Thus, a burglar can not drive the vehicle away.

There has been a so-called anti-burgling system. An anti-burgling system includes several sensors and an alert. When a door is opened, a window is broken or a wheel is pierced, one of the sensors senses it and actuates the alert in order to warn the owner of the vehicle.

Recently, global positioning system (GPS) has been used for the security of vehicles. When a vehicle is driven away by a burglar, the vehicle will be tracked so that the police can bust the burglar.

The above-mentioned security apparatuses and systems of course cause some troubles for burglars; however, in practice, these security apparatuses and systems may only stop the burglars for a short period of time. Such a short period of time is insufficient for the owner or the police to come to stop the burglary Even worse, once picked or destroyed, these security apparatuses, even the GPS, all fail to provide useful information for the owner or the police to determine the burglar.

There has been a traffic security apparatus for busting vehicles running faster than a speed limit and vehicles running across a stop line. The traffic security apparatus includes a sensing-device for sensing vehicles running faster than a speed limit and vehicles running across a stop line and a camera for taking pictures of such vehicles and for storing such pictures in a film. Collection of such films is manual and hence time consuming and expensive. Furthermore, it often happens that the camera runs out of film and hence fails to take pictures. Generally, the camera is located in a position that it is reachable by an average person for the convenience of the collection of such films. However, the camera is inevitably vulnerable to attacks.

### SUMMARY OF THE INVENTION

It is the primary objective of the present invention to overcome the problem encountered in the use of the conventional security apparatuses and systems by providing a security system capable of providing useful information for the police even if the security system is destroyed later.

The security system includes a picture-taking device, a data-transmitting device, a sensing device and a controller. The picture-taking device takes pictures and transforms the pictures into data. The data-transmitting device transmits the data. On sensing an external force, the sensor notifies the controller that in turn actuates the picture-taking device and the data-transmitting device.

It is another objective of the present invention to overcome the problems encountered in the use of the conventional traffic security apparatus by providing a traffic security system providing useful information for the police even if the security system is destroyed later.

The traffic security system includes a picture-taking device, a data-transmitting device, a sensing device and a controller. The picture-taking device takes pictures and transforms the pictures into data. The data-transmitting device transmits the data. On sensing a vehicle running faster than a speed limit or across a stop line, the sensor notifies the controller that in turn actuates the picture-taking device and the data-transmitting device.

### BRIEF DESCRIPTION OF THE DRAWINGS

The above-mentioned objectives and features and other objectives and features will be more fully appreciated from the following detailed description of preferred embodiments when considered in connection with the accompanying drawings in which like reference characters designate like or corresponding elements and wherein:

FIG. 1 is a block diagram of a security apparatus according to the present invention;

FIG. 2 is a block diagram of a security system in accordance with the present invention; and

FIG. 3 is a block diagram of a traffic security system according to the present invention.

### DETAILED DESCRIPTION OF THE PREFERRED EMBODIMENT

Security Apparatus

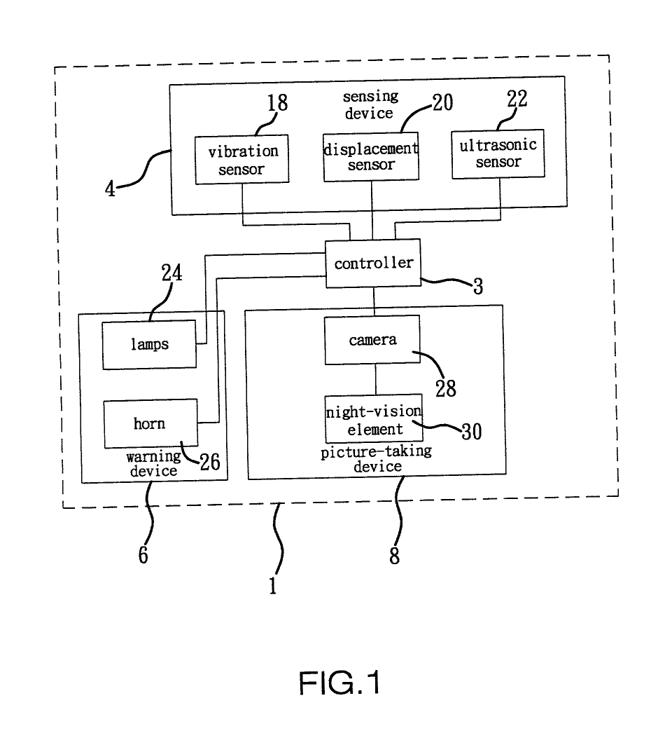

Referring to FIG. 1, a security apparatus according to the present invention is shown. The security apparatus includes a sensing device 4, a warning device 6, a picture-taking device 8 and a controller 3 for controlling the aforementioned devices.

The sensing device 4 is used to sense various forms of invasion and to send a signal to the controller when sensing a form of invasion. The various forms of invasion include but not limited to breaking of a window of a vehicle or building, piercing of a wheel of a vehicle, unauthorized opening of a door or window of a vehicle or building and unauthorized entering into a vehicle or building. The sensing device 4, accordingly, includes but not limited to a vibration sensor 18, a displacement sensor 20, an ultrasonic sensor 22 and other sensors. The vibration sensor 18 is used to sense vibration that is inherent of a window being broken or wheel being pierced, for example. The displacement sensor 20 is used to sense displacement that happens when a door or window of a vehicle or building is opened. The ultrasonic sensor 22 is used to sense movement of an object in a space. On sensing a certain form of invasion, each of these sensors sends a signal to the controller 3.

On receiving the signal from the sensing device, the controller 3 actuates the warning device 6 to warn the owner of the vehicle and/or any by-passer that the vehicle is being invaded in order to scare off the invader. When used in a vehicle, the warning device 6 includes lamps 24 and a horn 26. It should be noted that the warning device 6 is not essential in the security apparatus according to the present invention.

While actuating the warning device 6, the controller 3 further actuates the picture-taking device 8 to take pictures of the invader. The owner of the vehicle can obtain the pictures from the picture-taking device 8. The pictures can be used to determine the invader so that appropriate actions can be taken against the invader.

In the security apparatus shown in FIG. 1, the picture-taking device 8 includes a camera 28 and a night-vision element 30. The camera 28 is of course used to take pictures. The night-vision element 30 is used to ensure that the camera 28 takes clear pictures in the dark. The use of the night-vision element 30 is advantageous because it does not emit light when working and hence will not be easily found and destroyed by the invader. Instead of the night-vision element 30, a flash light lamp may be used to ensure that the camera 28 takes pictures in the dark; however, a flash light lamp will be easily found and destroyed by the invader.

One pair of the camera 28 and the night-vision element 30 is shown in FIG. 1; however, two or more such pairs may be used for ensuring that the picture-taking device 8 takes pictures of the invader regardless of the direction in which the invader approaches the vehicle.

As mentioned above, the security apparatus shown in FIG. 1 is practical in function and cheap in cost; however, it is not capable of reserving the pictures for the owner if the vehicle is driven away by the invader or if the invader destroys the security apparatus.

To improve the safety apparatus shown in FIG. 1, a security system has been developed and will be described.

Security System

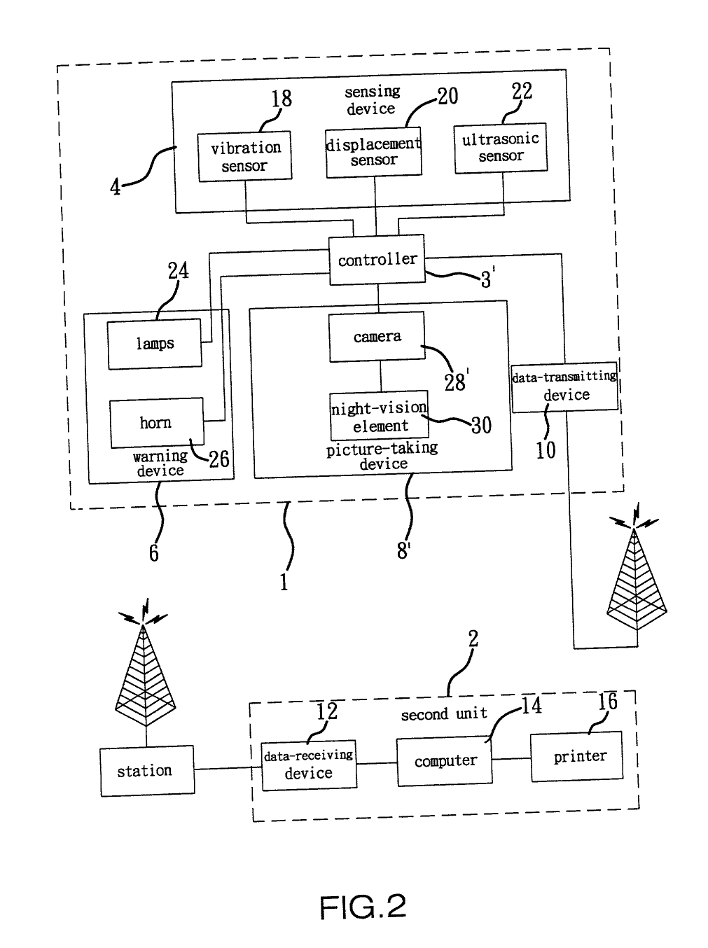

Referring to FIG. 2, the security system according to the present invention is shown. The security apparatus shown in FIG. 1 is improved by means of introduction of transmission of data, thus resulting in the security system shown in FIG. 2. The security system includes a first unit 1 installed in a vehicle or building and a second unit 2 installed in a place away from the vehicle or building. Unlike in the security apparatus shown in FIG. 1, in the security system shown in FIG. 2, the pictures taken in first unit 1 are transmitted to the second unit 2. Hence, even if the vehicle is driven away by the invader, the pictures of the invader will still be available to the owner.

Referring to FIG. 2, the first unit I consists of the sensing device 4, the warning device 6, a picture-taking device 8′, a data-transmitting device 10, and a controller 3′ for controlling the aforementioned devices.

The sensing device 4 and the warning device 6 of the security system shown in FIG. 2 are identical to the sensing device 4 and the warning device 6 of the security apparatus shown in FIG. 1 and hence will not be described in detail again.

The picture-taking device 8′ of the security system shown in FIG. 2 is identical to the picture-taking device 8 of the security apparatus shown in FIG. 1 except for use of a camera 28′ instead of the use of the camera 28. In the security apparatus shown in FIG. 1, the pictures are not transmitted and hence the camera 28 may be a conventional camera that stores pictures in a film. In the security system shown in FIG. 2, the pictures are taken and transmitted and hence the camera 28′ can not be a conventional camera that stores pictures in a film. That is, in addition to taking pictures, the camera 28′ must be able to transform the pictures into data that can be transmitted. The camera 28′ may transform the pictures into digital or analog data depending on the data-transmitting device 10. To transform the pictures into digital data, the camera 28′ may be a digital camera, for example. To transform the pictures into analog data, the camera 28′ may be a so-called V8 camera.

The data-transmitting device 10 is used to transmit the data transformed, by means of the picture-taking device 8′, from the pictures taken by means of the picture-taking device 8′.

When used in the vehicle, the data-transmitting device 10 transmits data in a wireless manner so that the transmission of the data will not be interrupted even if the vehicle is driven away by means of the invader. Thus, the owner can receive and transform the data into pictures and determine the invader based on the pictures. In the preferred embodiment, the data-transmitting device 10 is a mobile phone capable of transmitting digital data and accordingly the camera 28′ is a digital camera. The data-transmitting device 10 may be a GSM mobile phone, a satellite mobile phone or the like.

When used in the building, the data-transmitting device 10 may transmit data in a wireless manner as used in the vehicle. Alternatively, the data-transmitting device 10 may transmit data through a wire or line or cable since the building is generally not movable so that the transmission of the data will not be interrupted. Thus, the owner can receive and transform the data into pictures and determine the invader based on the pictures. In this case, the data-transmitting device 10 may be a mobile phone capable of transmitting digital data and accordingly the camera 28′ is a digital camera. Alternatively, the data-transmitting device 10 may be a combination of a modem with a telephone and accordingly the camera 28′ is a digital camera. Or, the data-transmitting device 10 may be configured based on a cable-television system and accordingly the camera 28′ may be a so-called V8 camera.

The controller 3′ is identical to the controller 3 except for control of the data-transmitting device 10. While actuating the warning device 6 and the picture-taking device 8, the controller 3′ further actuates the data-transmitting device 10.

The second unit 2 includes a data-receiving device 12. The data-receiving device 12 receives the data from the data-transmitting device 10. It is obvious that the data-receiving device 12 is configured in a manner corresponding to the manner in which the data-transmitting device 10 is configured. When the data-transmitting device 10 is a mobile phone or a combination of a modem with a telephone, the data-receiving device 12 may be a mobile phone or a combination of a conventional phone with a modem. When the data-transmitting device 10 is configured based a cable television system, the data-receiving device 12 is also made based on a cable television system.

The second unit 2 includes a computer 14 for receiving the data from the data-receiving device 12 and for processing the same and a printer 16 for receiving the data from the computer 14 and for printing the pictures of the invader based on the data.

The security system shown in FIG. 2 is powerful when used in connection with the police. In this case, the second unit 2 is installed in a police station. Once invasion happens in the vehicle or building, policemen will receive the pictures of the invader. Thus, on their way to the building, with the help of the pictures, policemen may find the invader trying to drive the vehicle away or to escape from the building. Similarly, the security system shown in FIG. 2 may be used in connection with a private security company.

Picture Taking and Transmitting Apparatus

The picture-taking device 8 and the data-transmitting device 10 can be combined into a picture taking and transmitting apparatus being useful in real-time transmission of pictures to a far-away and/or secure place. The picture taking and transmitting apparatus may be a handy tool for a tourist or reporter, for example. If made really small, the picture taking and transmitting device may be used as a handy tool for a reporter or detective, for example, or as a personal security apparatus for an average person and, more particularly, a female, since it can be concealed or hidden easily.

Traffic Security System

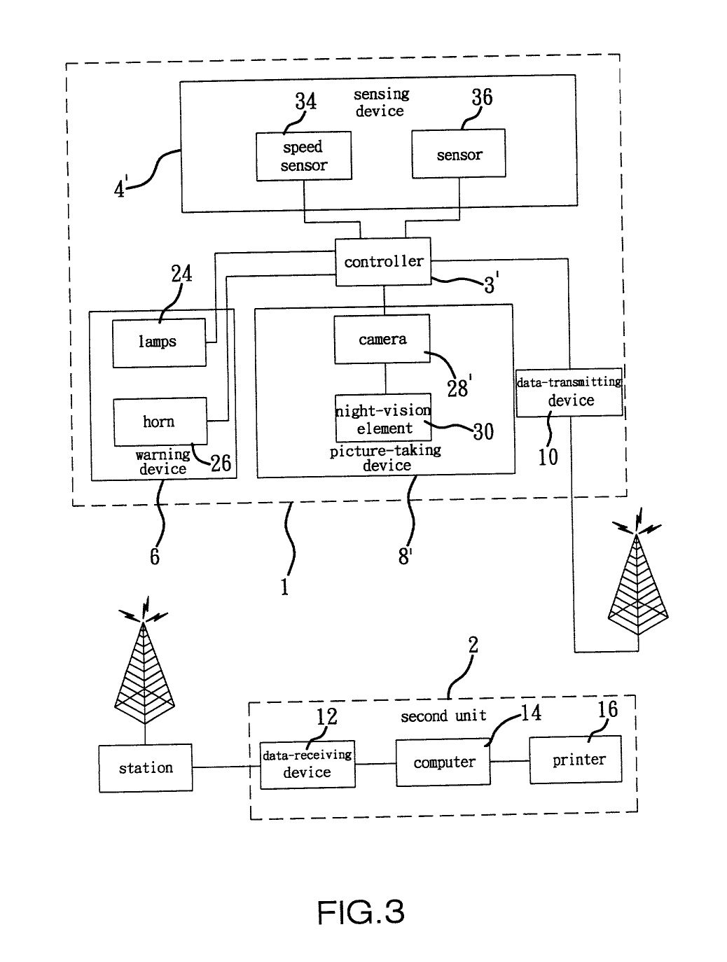

The security system shown in FIG. 2 can be modified to become a traffic security system shown in FIG. 3. The traffic security system is identical to the security system except for use of a sensing device 4′ instead of the use of the sensing device 4.

The sensing device 4′ includes a speed sensor 34. The speed sensor 34 is used to measure the speed of every vehicle passing by. The measured speed is compared to a speed limit stored in the speed sensor 34. If the speed is greater than the speed limit, a signal will be sent to the controller 3′ from the speed sensor 34. Otherwise, no signal will be sent to the controller 3′. On receiving the signal, the controller 3′ actuates the picture-taking device 8 and the data-transmitting device 10 as mentioned above. With the use of the speed sensor 34, the traffic security system is capable of busting vehicles running faster than the speed limit.

The sensing device 4′ includes a sensor 36 connected with a traffic sign (not shown). On turning to a stop sign, the traffic sign sends a signal to the sensor 36. Then, the sensor 36 starts to sense any vehicle running across a stop line and, if so, sends a signal to the controller 3′. On receiving the signal, the controller 3′ actuates the picture-taking device 8 and the data-transmitting device 10 as mentioned above. With the use of the sensor 36, the traffic security system is capable of busting any vehicle running across the stop line. For example, the sensor 36 may be a weight sensor that sends a signal to the controller 3′ when sensing a weight greater than a predetermined value. The weight sensor is buried in the ground beyond the stop line. Thus, when a vehicle runs across the stop line, the weight sensor senses the weight of the vehicle. Alternatively, the sensor 36 may be a pair of infrared emitter and receiver. The infrared emitter and receiver are installed at two ends of the stop line respectively. Thus, when a vehicle runs over the stop line, it interrupts the communication between the infrared emitter and receiver so that a signal is sent from the infrared receiver to the controller 3′.

Unlike a conventional traffic security system using a camera that stores pictures in a film, the traffic security system in accordance with the present invention uses the picture-taking device 8 and the data-transmitting device 10. Obviously, no film is to be collected in accordance with the present invention. Hence, the picture-taking device 8, namely the lens of the camera 28′, can be located in a position too high for people to reach without use of an appropriate tool so that it will not be damaged easily. However, other devices of the first unit 1 can be located in a lower position so that they can be maintained and repaired easily.

Obviously, many modifications and variations of the present invention are possible in light of the above teachings. It is therefore to be understood that within the scope of the appended claims, the present invention may be practiced otherwise than as specifically described herein.

What is claimed is:

1. A security apparatus comprising:
a controller;
a sensing device connected with the controller, on sensing an external force, the sensor sending a signal to the controller; and
a picture-taking device connected with the controller, on receiving the signal, the controller actuating the picture-taking device.

2. An apparatus in accordance with claim 1 wherein the picture-taking device includes a camera.

3. An apparatus in accordance with claim 2 wherein the camera takes pictures and stores the pictures in a film.

4. An apparatus in accordance with claim 2 wherein the camera is a digital camera.

5. An apparatus in accordance with claim 2 wherein the camera is a V8 camera.

6. An apparatus in accordance with claim 1 wherein the picture-taking device is operable in the dark.

7. An apparatus in accordance with claim 6 wherein the picture-taking device includes a camera and a night-vision element.

8. An apparatus in accordance with claim 6 wherein the picture-taking device includes a camera and a flash light lamp.

9. An apparatus for taking and transmitting picture, the apparatus comprising:
a picture-taking device for taking pictures and for transforming the pictures into data; and
a data-transmitting device for transmitting the data transformed by means of the picture-taking device.

10. An apparatus in accordance with claim 9 wherein the picture-taking device includes a camera.

11. An apparatus in accordance with claim 10 wherein the camera is a digital camera.

12. An apparatus in accordance with claim 10 wherein the camera is a V8 camera.

13. An apparatus in accordance with claim 9 wherein the data-transmitting device includes a mobile phone.

14. An apparatus in accordance with claim 9 wherein the data-transmitting device includes an analog-to-digital converter for converting the data from digital to analog and a telephone for transmitting the analog data.

15. An apparatus in accordance with claim 14 wherein the analog-to-digital converter is a modem.

16. An apparatus in accordance with claim 9 wherein the data-transmitting device includes a cable for a cable telephone system.

17. An apparatus in accordance with claim 9 wherein the picture-taking device is operable in the dark.

18. An apparatus in accordance with claim 17 wherein the picture-taking device includes a camera and a night-vision element.

19. An apparatus in accordance with claim 17 wherein the picture-taking device includes a camera and a flash light lamp.

20. A security system comprising the picture taking and transmitting apparatus as defined in claim 9.

21. A security system in accordance with claim 20 comprising a controller and a sensing device, wherein on sensing an external force, the sensor notifies the controller which in turn actuates the picture-taking device and the data-transmitting device.

22. A security system in accordance with claim 21 wherein the picture-taking device includes a camera.

23. A security system in accordance with claim 22 wherein the camera is a digital camera.

24. A security system in accordance with claim 22 wherein the camera is a V8 camera.

25. A security system in accordance with claim 21 wherein the data-transmitting device includes a mobile phone.

26. A security system in accordance with claim 21 wherein the data-transmitting device includes an analog-to-digital converter for converting the data from digital to analog and a telephone for transmitting the analog data.

27. A security system in accordance with claim 26 wherein the analog-to-digital converter is a modem.

28. A security system in accordance with claim 21 wherein the data-transmitting device includes a cable for a cable telephone system.

29. A security system in accordance with claim 21 wherein the picture-taking device is operable in the dark.

30. A security system in accordance with claim 29 wherein the picture-taking device includes a camera and a night-vision element.

31. A security system in accordance with claim 29 wherein the picture-taking device includes a camera and a flash light lamp.

32. A traffic security system comprising the picture taking and transmitting apparatus as defined in claim 9.

33. A traffic security system in accordance with claim 32 comprising a controller and a sensing device, wherein on sensing a vehicle running faster than a speed limit, the sensor notifies the controller which in turn actuates the picture-taking device and the data-transmitting device.

34. A traffic security system in accordance with claim 32 comprising a controller and a sensing device, wherein on sensing a vehicle running across a stop line, the sensor notifies the controller which in turn actuates the picture-taking device and the data-transmitting device.

35. A traffic security system in accordance with claim 32 wherein the picture-taking device includes a camera.

36. A traffic security system in accordance with claim 35 wherein the camera is a digital camera.

37. A traffic security system in accordance with claim 35 wherein the camera is a V8 camera.

38. A traffic security system in accordance with claim 32 wherein the data-transmitting device includes a mobile phone.

39. A traffic security system in accordance with claim 32 wherein the data-transmitting device includes an analog-to-digital converter for converting the data from digital to analog and a telephone for transmitting the analog data.

40. A traffic security system in accordance with claim 39 wherein the analog-to-digital converter is a modem.

41. A traffic security system in accordance with claim 32 wherein the data-transmitting device includes a cable for a cable telephone system.

42. A traffic security system in accordance with claim 32 wherein the picture-taking device is operable in the dark.

43. A traffic security system in accordance with claim 42 wherein the picture-taking device includes a camera and a night-vision element.

44. A traffic security system in accordance with claim 42 wherein the picture-taking device includes a camera and a flash light lamp.
